(19) United States
(12) Patent Application Publication
(10) Pub. No.: US 2014/0120763 A1
(43) Pub. Date: May 1, 2014

(54) CONNECTOR

(71) Applicant: Sumitomo Wiring Systems, Ltd., Yokkaichi-City (JP)

(72) Inventors: Kiyotaka Itsuki, Yokkaichi-City (JP); Sho Miyazaki, Yokkaichi-City (JP)

(73) Assignee: Sumitomo Wiring Systems, Ltd., Yokkaichi-City (JP)

(21) Appl. No.: 14/050,631

(22) Filed: Oct. 10, 2013

(30) Foreign Application Priority Data
Oct. 25, 2012 (JP) 2012-235745

(51) Int. Cl. H01R 13/533

(52) U.S. Cl. CPC H01R 13/533
USPC 439/382

(57) ABSTRACT

A connector (10) into which wires (60) each formed by covering a flexible core (61) with an insulation coating (62) are introduced includes female terminals (40) to be connected to ends of the wires (60), and a housing main body (20) for accommodating end portions of the wires (60) connected to the female terminals (40). Vibration absorbing portions (63) formed by removing the insulation coatings (62) are provided in parts of the wires (60) to be accommodated into the housing main body (20).

### BACKGROUND

1. Field of the Invention

The present invention relates to a connector.

2. Description of the Related Art

Japanese Unexamined Patent Publication No. 2000-277217 discloses a connector that prevents trouble in connector connection due to a dimensional accuracy error. This connector has a spring washer with a leaf spring arranged between a connector main body and a bottom plate. The leaf spring deflects when a mating connector is inserted, and the connector main body pivots according to the position of the mating connector.

The above-described connector may be mounted on an end of a wire fixed to a vehicle, and a wire pulled out from the connector main body vibrates with vibration of the vehicle. This vibration is transmitted to a terminal connected to an end of the wire via the wire arranged in the connector main body and may cause trouble in connected parts of the terminal and a mating terminal provided in the mating connector.

An intermediate terminal could connect the conductive member to the end of the wire to cause a flexible conductive member to absorb vibration, but this approach increases the number of operation steps, the number of components and the cost.

The invention was completed in view of the above and an object thereof is to block vibration transmitted to a terminal without increasing the number of operation steps and the number of components.

### SUMMARY OF THE INVENTION

The invention is directed to a connector into which a wire is introduced. The wire has a flexible core with an insulation coating. The connector has a terminal to be connected to an end of the wire and a housing for accommodating the terminal and a part of the wire inside. A vibration absorbing portion is formed by removing insulation coating on a part of the wire to be accommodated into the housing. The flexible vibration absorbing portion is formed by removing more of the insulation coating than the minimum necessary for connection to the terminal. This enables vibration to be blocked and absorbed without increasing the number of components and the number of operation steps.

The housing may be fit into a mounting hole in a case of a device, and the vibration absorbing portion may be bent in a direction intersecting a fitting direction of the housing.

A high-voltage wire generally has a thick insulation coating and therefore is rigid. Thus, the high-voltage wire cannot be bent at a right angle with a small bending radius with the wire arranged in the housing. However, the bending radius can be made smaller by removing the insulation coating of the wire. The bent wire then can be disposed in the housing and functions as a vibration absorbing portion.

The connector may further comprise a fixing member for fixing the part of the wire in the housing. Vibration is blocked more reliably at the part where the fixing member fixes the wire to the housing.

The fixing member may include a press-fitting portion to be press-fit into the housing. Thus, the number of components and the number of operation steps can be reduced as compared with the case where a nut is embedded in the housing and the fixing member is fixed to the housing by a bolt.

The press-fitting portion may be press-fit in a direction intersecting a direction in which the wire is introduced thereby further blocking vibration transmitted along the wire.

The vibration absorbing portion may be bent in the housing, and the fixing member may be fixed between a part where the wire is introduced into the housing and the bend of the wire that forms the vibration absorbing portion.

Large vibration is transmitted from the part where the wire is introduced to the position where the fixing member is fixed. Thus, a vibration load may concentrate on a bent portion where a load is more likely to act than on a straight part. As a result, the bent portion may be deformed and damaged if the fixing member is provided closer to the terminal than the bent portion. However, the fixing member is arranged closer to the side where the wire is introduced than the bent portion. Therefore, the bent portion is less likely to be deformed and damaged due to vibration as compared with the case where the fixing member is fixed closer to the terminal than the bent portion.

Further, a long length can be set from a position where the terminal is connected to a position where the fixing member is fixed to the vibration absorbing portion as compared with the case where the fixing member is fixed closer to the terminal than the bent portion. Thus, even if all of the vibration cannot be blocked by fixing the wire to the housing, the vibration leaking from the part fixed to the housing can be absorbed sufficiently since a large length is set for the vibration absorbing portion. In this way, the vibration transmitted to the terminal can be blocked reliably.

The fixing member may be arranged between a corner of the housing and the vibration absorbing portion. Thus, the vibration absorbing portion will not be damaged, such as by being abraded against the corner formed in the housing.

### BRIEF DESCRIPTION OF THE DRAWINGS

FIG. 1 is a perspective view of a connector.

FIG. 2 is a front view of the connector.

FIG. 3 is a side view of the connector.

FIG. 4 is an exploded perspective view of the connector.

FIG. 5 is a perspective section of the connector when viewed obliquely from a front upper side.

FIG. 6 is a section along A-A of FIG. 2.

FIG. 7 is a section along B-B of FIG. 3.

FIG. 8 is a section along C-C of FIG. 3.

FIG. 9 is an enlarged section of an essential part of FIG. 8.

FIG. 10 is a front view showing a state where a vibration absorbing portion of a wire is arranged on a fixing member.

FIG. 11 is a side view showing the state of FIG. 10.

FIG. 12 is a plan view showing the state of FIG. 10.

### DETAILED DESCRIPTION OF THE PREFERRED EMBODIMENTS

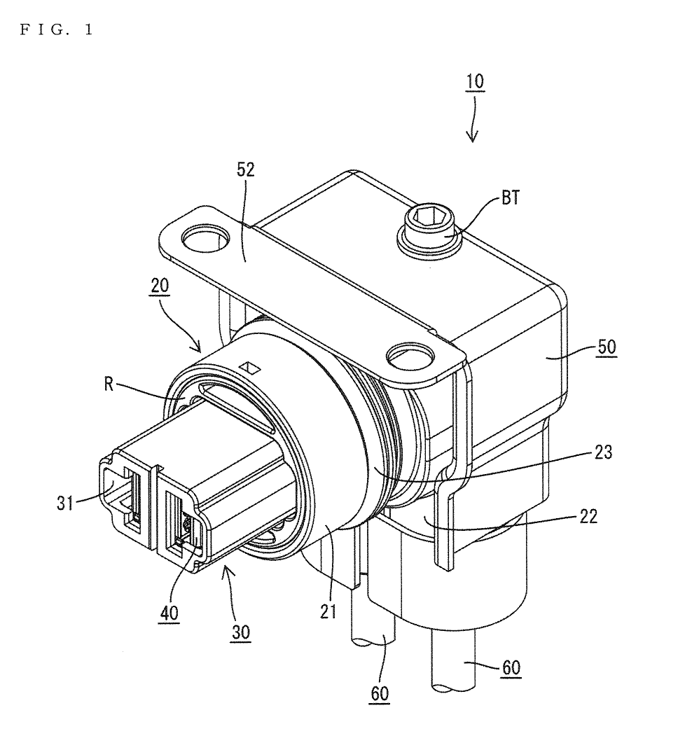

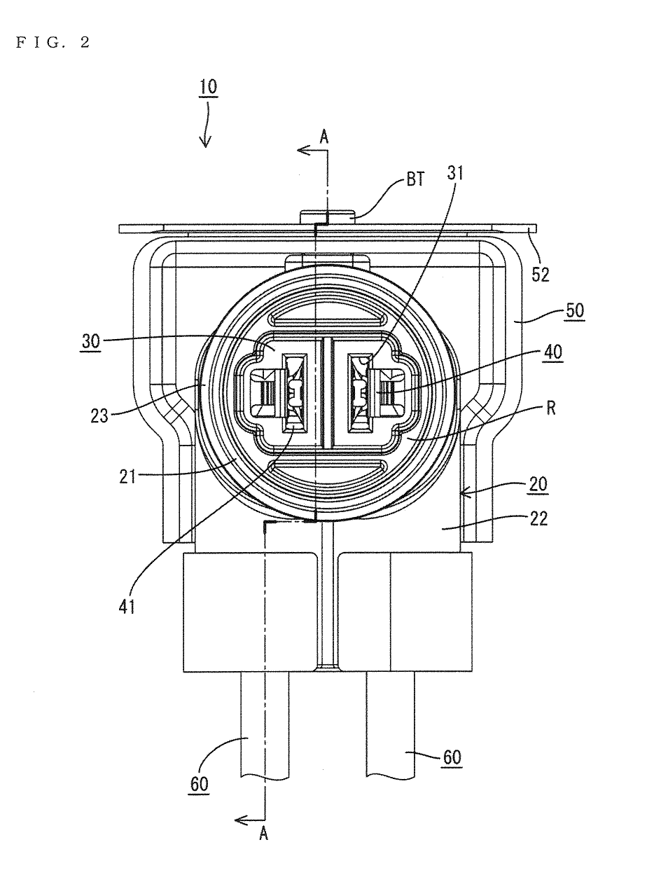

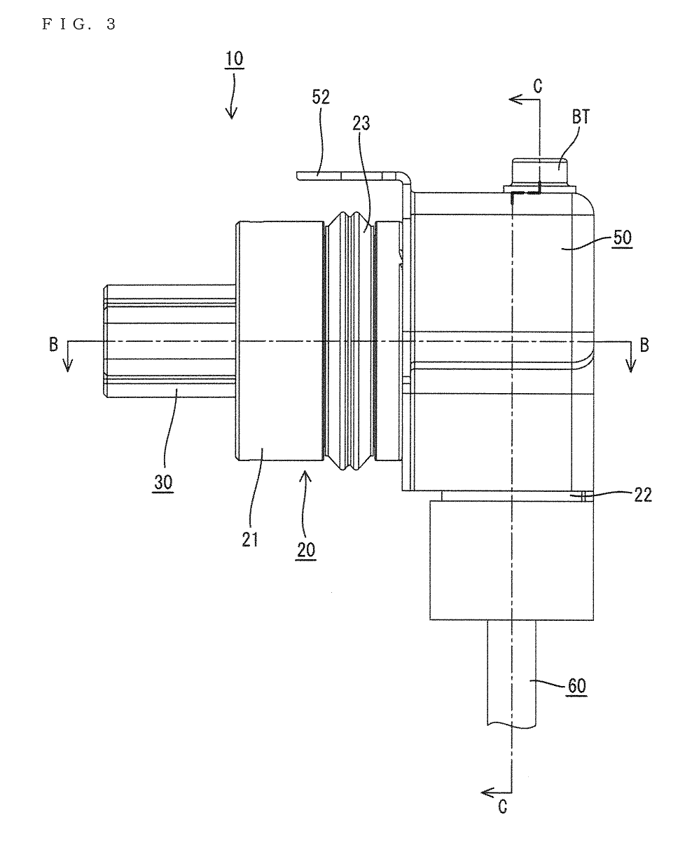

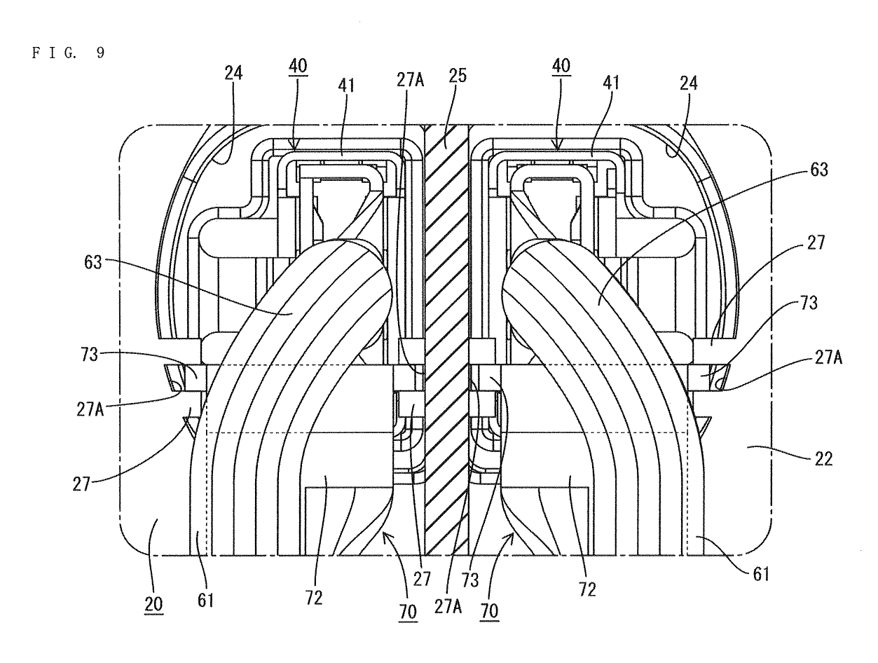

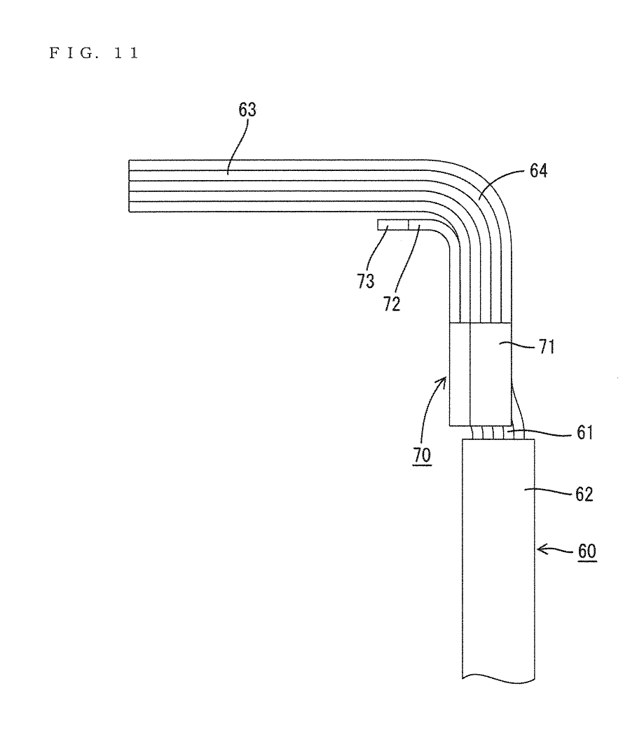

A connector in accordance with the invention is identified by the numeral 10 in FIGS. 1-12. The connector 10 accommodates high-voltage wires 60 and is mounted on a shield case (not shown) of a device (e.g. inverter, motor or the like of a vehicle such as a hybrid vehicle or an electric vehicle). A device-side connector (not shown) is connectable to the connector 10 is arranged at a position facing the connector 10 in a connecting direction in the shield case. In the following description, a vertical direction is based on that of FIG. 3 and a lateral direction is based on that of FIG. 2. Further, forward and backward directions are based on lateral directions of FIG. 3, with a left direction (connecting direction to the device-side connector) referred to as a forward direction and a right direction referred to as a backward direction.

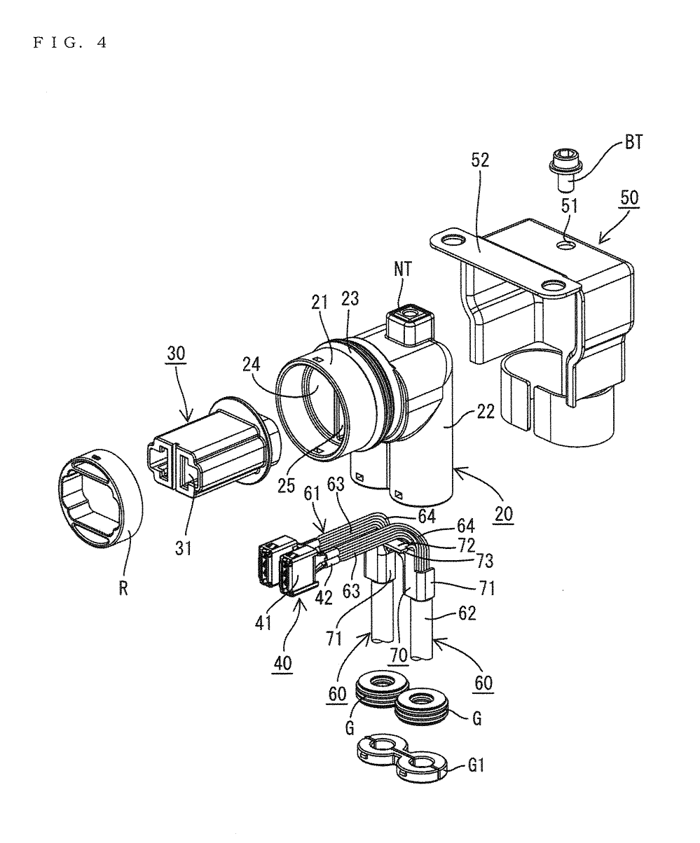

As shown in FIG. 4, the connector 10 includes a substantially L-shaped housing main body 20, a front housing 30 connectable to the device-side connector, female terminals 40 connected to ends of wires 60, and a shield shell 50 covering the housing main body 20. Note that a combination of the housing main body 20 and the front housing 30 defines the housing of the invention.

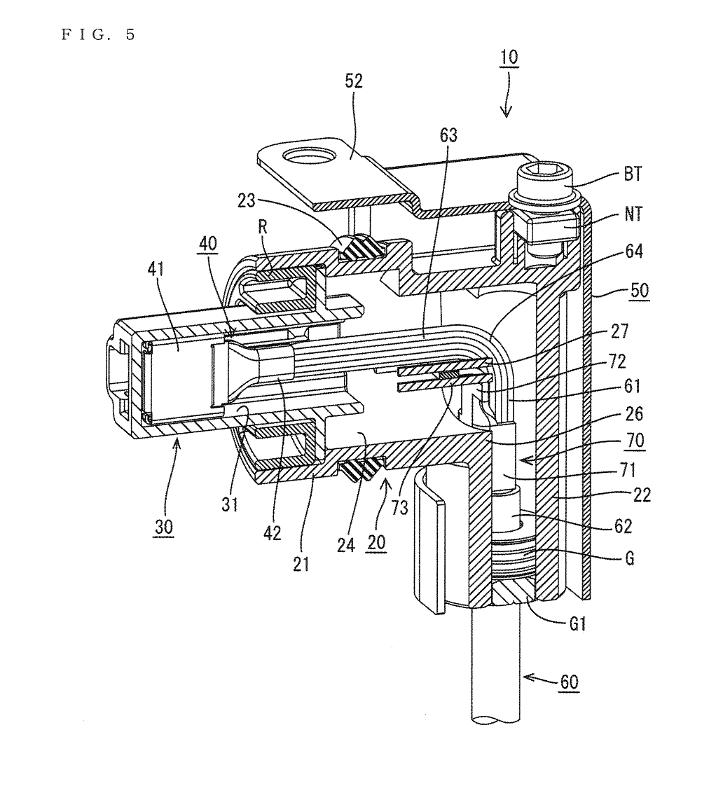

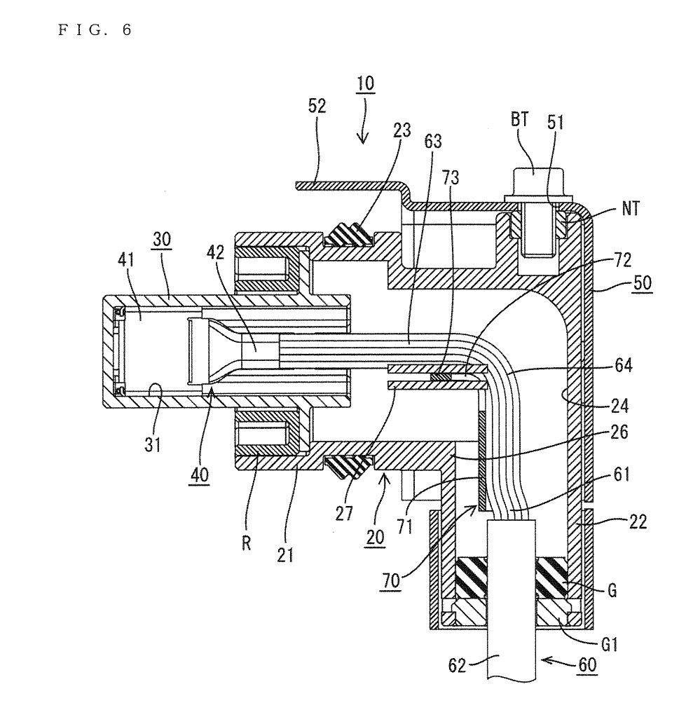

The housing main body 20 is made of synthetic resin and, as shown in FIGS. 5 and 6, and defines an L shape with a fitting portion 21 at one end and a wire introducing portion 22 at the opposite end. The fitting portion 21 can fit into a mounting hole (not shown) provided in the shield case and the wire introducing portion 22 receives the wires 60 introduced from below.

A seal ring 23 is fit externally on the outer peripheral surface of the fitting portion 21 and seals between the inner peripheral surface of the mounting hole and the outer peripheral surface of the fitting portion 21 when the fitting portion 21 is fit into the mounting hole of the shield case.

As shown in FIG. 6, a rear half of the front housing 30 is fit into the fitting portion 21 from the front. A front half of the front housing 30 projects from the front surface of the fitting portion 21 when the front housing 30 is fit into the fitting portion 21. Further, the front housing 30 is retained by an annular front retainer R, as shown in FIGS. 4 and 5, so as not to come out forward.

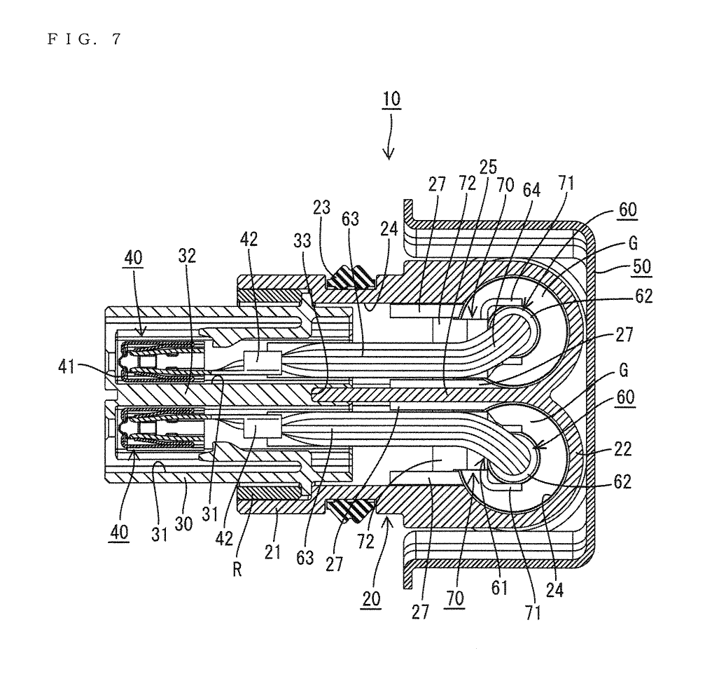

Two cavities 31 are provided side by side in the lateral direction in the front housing 30 and are partitioned by a partition wall 32, as shown in FIG. 7. The female terminals 40 are held and retained in the cavities 31, and two wires 60 are pulled out backward from a rear part of the front housing 30.

Each wire 60 has a flexible core 61 made up of a plurality of metal strands and an insulation coating 62 covers the core 61. The core 61 has sufficient elasticity to be deflectable in a direction intersecting an axial direction, but the wire 60 covered by the insulation coating has high rigidity and a large bending radius.

The female terminal 40 has a rectangular tubular terminal connecting portion 41 and a barrel 42 behind the terminal connecting portion 41. The terminal connecting portion 41 is to be connected to an unillustrated male terminal in the device-side connector and the barrel 42 is to be crimped to an end of the core 61 exposed in the wire 60.

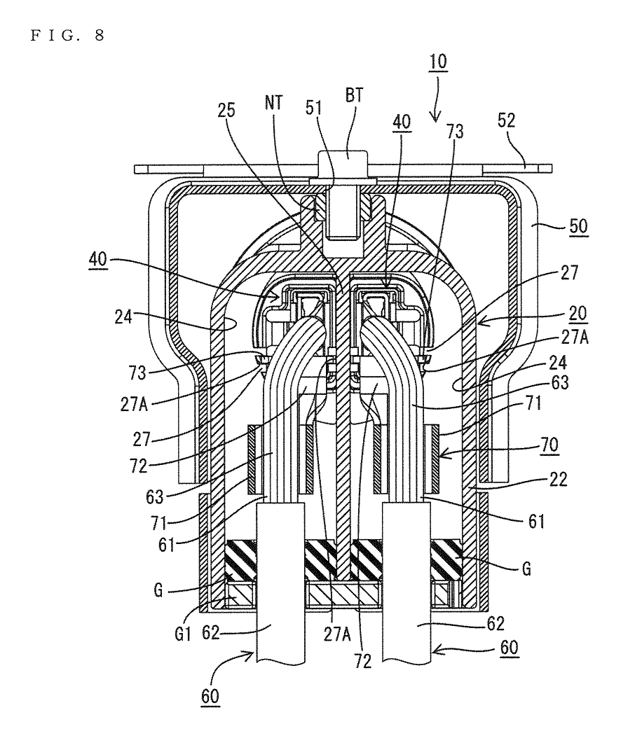

As shown in FIGS. 7 and 8, left and right main-body cavities 24 are formed in the housing main body 20 and are partitioned by a main-body side partition wall 25 that extends from the fitting portion 21 to the wire introducing portion 22. The wires 60 are inserted individually into the main-body side cavities 24.

A front end of the main-body partition wall 25 is fit into a recess 33 on a rear part of the partition wall 32 when the rear end of the front housing 30 is fit into the fitting portion 2. Thus an area from the cavities 31 of the front housing 30 to the main-body cavities 24 of the housing main body 20 is divided into completely laterally independent areas. Specifically, the partition wall 32 and the main-body partition wall 25 completely separates the wires 60 inserted into the front housing 30 and the housing main body 20.

As shown in FIGS. 6 and 8, two rubber plugs G are fit externally on the wires 60 and a rubber plug presser G1 is accommodated in a lower end part of the wire introducing portion 22 for retaining the rubber plugs G from below. The rubber plugs G provide sealing between the respective wires 60 and the wire introducing portion 22 by being held in close contact with the outer peripheral surfaces of the wires 60 and the inner peripheral surface of the wire introducing portion 22 over the entire circumference.

The shield shell 50 is made of a conductive iron metal material and shaped to cover a part of the housing main body 20 other than the fitting portion 21, as shown in FIGS. 6 and 7. Note that the shield shell may be made of a conductive metal material such as aluminum or aluminum alloy other than iron.

A bolt insertion hole 51 is formed in the upper surface of the shield shell 50, a bolt BT is inserted into the bolt insertion hole 51 and tightened to a nut NT fixed to an upper part of the housing main body 20 to fix the shield shell 50 to the housing main body 20.

A mounting piece 52 to be mounted and fixed to the shield case projects forward from the upper front edge of the shield shell 50. The shield shell 50 is connected electrically to the shield case by fixing the mounting piece 52 to the shield case.

As shown in FIGS. 5 to 7, the core 61 is exposed by removing the insulation coating 62 from a position where the female terminal 40 is connected to a position where the rubber plug G is fit externally to form a flexible vibration absorbing portion 63. Specifically, vibration transmitting along the wire 60 from outside can be absorbed in the vibration absorbing portion 63. In this way, vibration can be blocked in the vibration absorbing portion 63 without increasing the number of components and the number of operation steps as compared with the case where a vibration absorbing portion is provided separately by connecting a flexible conductive member to the end of the wire 60 using an intermediate terminal or the like. Note that although a large area of the cores 61 is exposed at the ends of the wires 60 by removing the insulation coatings 62, the two wires 60 arranged in the connector 10 are completely separated and insulated by the partition wall 32 and the main-body side partition wall 25.

The vibration absorbing portion 63 includes a bent portion 64 bent substantially at a right angle to extend down by removing the insulation coating 62 of the wire 60. The wire 60 is a high-voltage wire, and therefore the insulation coating 62 is thick and highly rigid. Thus, a bending radius of the wire 60 cannot be made smaller. However, the insulation coating 62 is removed along a large area to form the vibration absorbing portion 63 so that a bending radius of the bent portion 64 (vibration absorbing portion 63) can be made smaller as compared with the case where a part covered with the insulation coating 62 is bent. In this way, the high-voltage wires 60 can be arranged easily in the housing main body 20.

A fixing member 70 is fixed to a part of the vibration absorbing portion 63 below the bent portion 64. The fixing member 70 is formed by press-working a metal material and includes a wire fixing portion 71 to be fixed to the vibration absorbing portion 63 and a press-fitting portion 72 to be press-fitted into the housing main body 20.

The wire fixing portion 71 has a substantially U-shaped cross-section so as to cover the front side and both left and right sides of the vibration absorbing portion 63 and is fixed to the vibration absorbing portion 63 by a known method such as brazing, soldering, welding or the like.

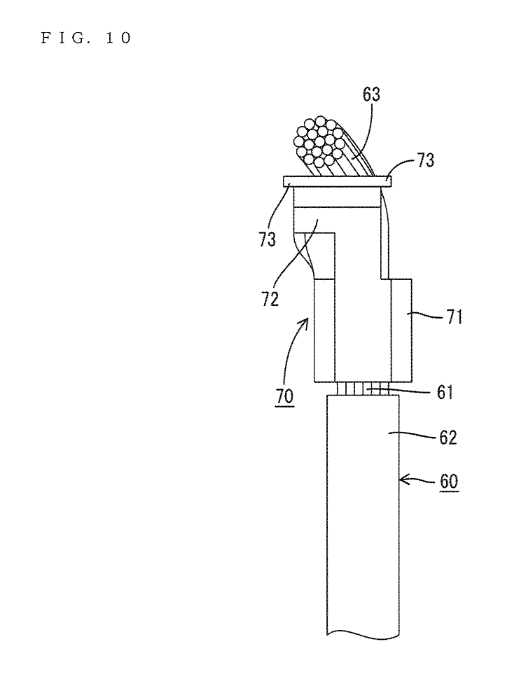

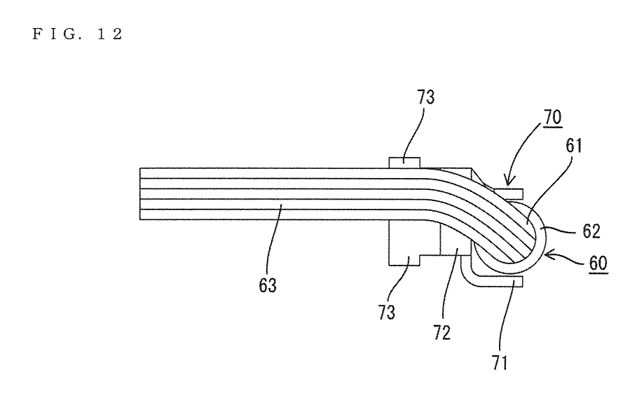

The press-fitting portion 72 extends up from the front upper end of the wire fixing portion 71 and then extends forward to define and L shape. The press-fitting portion 72 is arranged at the inner side of the bent portion 64 of the vibration absorbing portion 63. As shown in FIGS. 10 and 12, two press-fitting projections 73 protrude on opposite left and right sides of a front part of the press-fitting portion 72.

A substantially right-angled corner 26 is formed on the inner wall of the main-body cavity 24 of the housing main body 20 by coupling the fitting portion 21 and the wire introducing portion 22, as shown in FIGS. 5 and 6. Fixing portions 27 are formed on opposite left and right side walls located above the corner 26, as shown in FIGS. 7 to 9. The fixing portions 27 form a press-fitting recess 27A into which the press-fitting projection 73 of the press-fitting portion 72 is to be press-fit from the front. The fixing member 70 is fixed to the housing main body 20 by press-fitting the press-fitting projections 73 into the press-fitting recesses 27A. The press-fitting portions 72 are press-fit into the fixing portions 27 to be substantially perpendicular to a vibration transmission direction (vertical direction) along the wire 60. Thus, vibrations transmitted along the wire 60 are blocked initially at a position where the fixing member 70 is fixed to the housing main body 20. Specifically, vibrations transmitted along the wire 60 are blocked initially at a part where the fixing member 70 is fixed to the housing main body 20 and the vibration leaking from this part is absorbed reliably by the vibration absorbing portion 63. Thus, trouble in connected parts of the female terminal 40 and the male terminal are prevented reliably.

The press-fitting portion 72 is arranged between the corner 26 of the housing main body 20 and the vibration absorbing portion 63 as shown in FIGS. 5 and 6, thereby preventing the vibration absorbing portion 63 from being damaged by being abraded against the corner 26 of the housing main body 20.

The connector 10 is assembled initially by removing the insulation coating 62 an end portion of each wire 60. At this time, a larger part of the insulation coating 62 is removed than usual to form the vibration absorbing portion 63 on the end portion of the wire 60 by exposing the core 61 up to a position immediately before a position where the rubber plug G is to be mounted.

Subsequently, the rubber plugs G are mounted on the respective wires 60. The wires 60 then are inserted into the respective main-body cavities 24 from a lower part of the housing main body 20 and are pulled out from the fitting portion 21.

The female terminals 40 are crimped to the ends of the respective cores 61. The female terminals 40 then are inserted into the cavities 31 of the front housing 30 and are retained in the front housing 30. Thus, the front housing 30 is mounted on the ends of the wires 60.

The fixing members 70 then are fixed respectively to lower parts of the vibration absorbing portions 63 by brazing, soldering, welding or the like. The wires 60 then are pulled back and the press-fitting projections 73 of the press-fitting portions 72 of the fixing members 70 are press-fit into the press-fitting recesses 27A of the housing main body 20 from the front to fix the fixing members 70 to the fixing portions 27, as shown in FIGS. 5, 6 and 9. As a result, the wires 60 are fixed to the housing main body 20. Simultaneously, the rear end of the front housing 30 is fit into the fitting portion 21 and the main-body side partition wall 25 of the housing main body 20 is fitted into the recess 33 in the partition wall 32 of the front housing 30. Accordingly, the vibration absorbing portions 63 in the two wires 60 are completely separated and insulated.

Finally, the front retainer R is mounted to retain the front housing 30, and the shield shell 50 is fixed to the housing main body 20 by the bolt BT so that the housing main body 20 is covered by the shield shell 50.

As described above, the insulation coating 62 is removed over more than the part where the female terminal 40 is to be connected, thereby forming the flexible vibration absorbing portion 63. Thus, vibration is absorbed in the vibration absorbing portion 63 without increasing the number of components and the number of operation steps. Further, the bending radius of the vibration absorbing portion 63 can be made smaller as compared with the part covered with the insulation coating 62, which is advantageous in arranging the high-voltage wire 60 in the housing main body 20.

Further, the fixing member 70 fixed below the bent portion 64 (between the part of the wire 60 inserted into the wire introducing portion 22 and the bent portion 64) is fixed by being press-fit into the housing main body 20. Specifically, this embodiment is configured so that vibration transmitted along the wire 60 is blocked first at the part where the fixing member 70 is fixed to the housing main body 20 and, then, the vibration leaking from this part can be blocked and absorbed by the vibration absorbing portion 63. Thus, trouble in the connected parts of the female terminal 40 and the male terminal can be avoided reliably.

Large vibration is transmitted from the part of the wire 60 inserted into the wire introducing portion 22 to the position where the fixing member 70 is fixed. Thus, a vibration load may concentrate on a bent portion where a load is more likely to act than on a straight part and the bent portion may be deformed and damaged, for example, if the fixing member was closer to the female terminal than the bent portion. However, the fixing member 70 is fixed between the position where the wire 60 is introduced into the wire introducing portion 22 and the bent portion 64. Therefore, the bent portion 64 will not be deformed and damaged due to vibration as compared with the case where the fixing member is fixed closer to the female terminal than the bent portion.

The fixing member 70 is more distant from the female terminal 40 than the bent portion 64. Thus, a longer length can be set for the vibration absorbing portion 63 utilizing a distance from the position where the female terminal 40 is connected to the position where the fixing member 70 is fixed to the vibration absorbing portion 63 as compared with the case where the fixing member 70 is fixed closer to the female terminal than the bent portion. Hence, even if all vibrations cannot be blocked by fixing the fixing member 70 to the housing main body 20, the vibration leaking from the fixing member 70 can be absorbed sufficiently by setting a long length for the vibration absorbing portion 63.

The press-fitting portion 72 is press-fit in a direction (forward and backward directions) perpendicular to the vibration transmission direction (vertical direction) along the wire 60. Thus, vibrations transmitted along the wire 60 can be blocked further.

Furthermore, since the fixing member 70 is press-fit into and fixed to the housing main body 20, the number of components and the number of operation steps can be reduced as compared with the case where a nut is embedded in the housing main body and the fixing member is fixed to the housing by a bolt.

The invention is not limited to the above described embodiment. For example, the following embodiments are also included in the scope of the invention.

The vibration absorbing portion 63 is fixed to the housing main body 20 by the fixing member 70 in the above embodiment. However, the vibration absorbing portion may not be fixed to the housing main body.

The fixing member 70 is fixed to the vibration absorbing portion 63 in the above embodiment. However, the fixing member may be fixed to the insulation coating.

Although the fixing member 70 is press-fit into and fixed to the fixing portion 27 in the above embodiment, the invention is not limited to such a mode and, for example, the fixing member may be fixed to the housing main body by a bolt or the like.

The wire fixing portion 71 of the fixing member 70 is fixed by brazing, soldering, welding or the like in the above embodiment. However, the wire fixing portion may be crimped to the vibration absorbing portion.

The vibration absorbing portion 63 is formed by completely removing the insulation coating 62 in a part from the end of the wire 62 to the position before the mounted position of the rubber plug G in the above embodiment. However, the vibration absorbing portion may be formed by partly removing the insulation coating in the part from the end of the wire to the position before the mounted position of the rubber plug.

What is claimed is:

1. A connector (10), comprising:
a housing (20);
a terminal (40) accommodated in the housing (20); and
a wire (60) having a flexible core (61) extending from an end of the wire (60) and an insulation coating (62) covering the flexible core (61), the insulation coating (62) being removed for a selected length from the end of the wire (60) to define an exposed part of the flexible core (61), the terminal (40) being connected to the exposed part of the flexible core (61) in proximity to the end of the wire (60) and a vibration absorbing portion (63) being defined by the exposed part of the flexible core (61) disposed in the housing (20) and extending between the terminal (40) and the insulation coating (62).

2. The connector of claim 1, wherein:
the terminal (40) has a terminal connecting portion (41) extending in a connecting direction; and
the vibration absorbing portion (63) includes a bend (64) that is bent in a direction intersecting the connecting direction.

3. The connector (10) of claim 2, further comprising a fixing member (70) engaged with the housing (20) and with a part of the wire (60) in the housing (20) for fixing the wire (20) relative to the housing (20).

4. The connector (10) of claim 3, wherein the fixing member (70) includes a press-fitting portion (72) press-fit into the housing (20).

5. The connector (10) of claim 4, wherein the press-fitting portion is press-fit in a direction intersecting a longitudinal direction of the wire (60) between the vibration absorbing portion (63) and the insulation coating (62).

6. The connector (10) of claim 3, wherein:
the fixing member (70) is fixed between a part where the wire is introduced into the housing (20) and the bend (64) where the vibration absorbing portion (63) is bent.

7. The connector (10) of claim 6, wherein the fixing member (70) is arranged between a convex corner in the housing (20) and a concave surface of the bend (64) of the vibration absorbing portion (63).

8. The connector (10) of claim 1, wherein terminal (40) includes a barrel (41) connected to flexible core (61) of the wire (60), the vibration absorbing portion (63) being longer than the barrel (41) measured in a longitudinal direction of the wire (60).
